(19) United States
(12) Patent Application Publication
(10) Pub. No.: US 2006/0136891 A1
(43) Pub. Date: Jun. 22, 2006

(54) Upgrading software of networked devices

(75) Inventor: Jalil Oraee, Oxfordshire (GB)

Correspondence Address: FOLEY AND LARDNER LLP;SUITE 500, 3000 K STREET NW, WASHINGTON, DC, 20007, US

(73) Assignee: OXFORD SEMICONDUCTOR LIMITED

(21) Appl. No.: 10/549,292

(22) PCT Filed: Mar. 4, 2004
(86) PCT No.: PCT/GB04/00915

§ 371 Date: Nov. 14, 2005

(30) Foreign Application Priority Data
Mar. 20, 2003 (GB) 0306461.5

(51) Int. Cl. G06F 9/44

(52) U.S. Cl. 717/168

(57) ABSTRACT

Upgrading of devices in a network, such as an IEEE (1394) network, of digitally connected devices, such as AV devices, is performed using a reproduction device for reproducing a recording medium insertable in the reproduction device. A controller for controlling the reproduction device is arranged, on insertion in the reproduction device of a recording medium, to detect if the inserted recording medium has recorded thereon upgrade software for upgrading a target device in the network. If so, the controller causes the target device to be upgraded by the upgrade software.

The present invention relates to upgrading of devices in a network, for example audio-visual devices in an IEEE 1394 network intended for domestic or professional use.

Digitally interconnecting separate digital devices to form a network is very desirable because it provides the possibility that the devices can share data with each other and that different devices can exercise control over each other. As a result, the network of devices becomes more useful than if the individual devices were provided separately.

However, the usefulness of such a network depends on interoperability of the individual devices. At the very least this requires the individual devices to be able to transfer data between one another in a usable form. To achieve full benefit, it requires that the individual devices have a knowledge of the usable functions of other devices in the network. Providing interoperability of devices in a network creates significant problems, particularly when new devices are added to a network of legacy devices.

For example, it has been proposed to form networks of audio-visual devices (AV devices) for domestic use, such as in a home theatre system. As the AV devices gain more features and intelligence, such a network provides the possibility of the AV devices communicating in a digital matter and interoperating, rather than having simple analog interconnections for transferring program content alone. This has led to serious interoperability issues, for example ensuring that a first device, say a television, designed today can successfully interoperate with a second device, say a DVD player, designed in several years time. As a result, in practice manufacturers have been slow to develop devices that offer full interoperability.

To achieve interoperability, it would be useful to upgrade the software on existing devices in an existing network. Currently, many devices, in particular AV devices, cannot be easily upgraded by a user, unless additionally provided with their own in-built media port specifically designed to allow this. Where a personal computer is connected into the network, it is possible in some networks for the user to use the personal computer to upgrade the software in other devices in the network. However, this requires a high degree of skill and knowledge on the part of the user and is therefore difficult or impossible for many users.

According to one aspect of the present invention, there is provided a network of digitally connected devices including a reproduction device for reproducing a recording medium insertable in the reproduction device,

wherein a controller for controlling the reproduction device is arranged, on insertion of a recording medium in the reproduction device, to perform a process comprising:

detecting if the inserted recording medium has recorded thereon upgrade software for upgrading a target device in the network; and

if it is detected that the inserted recording medium has upgrade software recorded thereon upgrade software, sending the upgrade software to the target device over the network and causing the target device to be upgraded by the upgrade software.

According to further aspects of the present invention, there is provided a controller and a reproduction device suitable for use in a network according to the first aspect of the present invention, a method corresponding to the operation of the controller in the first aspect of the invention, and a recording medium suitable for use in the reproduction device.

In accordance with the invention, when the reproduction device has inserted therein a recording medium storing the upgrade software, the controller detects this fact and causes the target device in the network to be upgraded by the upgrade software. Thus, the present invention provides for devices in a network to be upgraded automatically simply by insertion of a recording medium having the upgrade software recorded thereon into a reproduction device in the network. As many types of network include a reproduction device as one of the digitally connected devices, the present invention may be implemented in those networks without the need for the devices to include in-built media ports.

Such automatic upgrading provides many advantages.

The automatic upgrade requires little or no skill on the part of the user. The upgrade may be performed by the devices of the network without any interaction with the user, although optionally the user may be given the option to confirm the upgrade or to control aspects thereof.

The upgrading allows devices in an existing network to be kept up-to-date with new standards and interoperability protocols. This gives the prospect of devices designed now being able to work with new devices designed in the future. This greatly simplifies the provision of interoperable devices, which may encourage manufacturers to increase the development of interoperable equipment, by allowing devices to follow changes in equipment protocols and standards.

The present invention also provides a mechanism for manufacturers to correct bugs in software found after supply of devices to users. This future proofing may be used to increase customer confidence and therefore provide a direct benefit to manufacturers. Depending on the commercial desires of the manufacture, the upgrade software could be offered free or could be part of a value-added service for which a charge is made, thereby giving the manufacturers a new revenue stream.

The present invention has a wide range of applicability. The upgrade software could be specific to one or more specific devices, or one or more types of devices. The upgrade software may be of any type, for example (but not exhaustively) firmware, application software or device drivers. The upgrade software could relate to aspects of: the functionality of the target device, for example the format of an on-screen display; interaction with the functionality of a different device in the network, for example to allow the target device to control a different device across the network; or network communication, for example to implement a new communication protocol.

It is a particular advantage of the present invention that the upgrade may be achieved without the user needing to control the upgrade from a personal computer. No additional equipment is needed. The upgrade may be achieved independently of the processor type or capability of the devices in the network and independent of any operating system which may be present in any network device.

There are many ways of delivering a recording medium having upgrade software to users which provide for flexibility providing in the upgrade process to consumers. For example, the recording medium might be provided together with a new device for connection into the network. In this case, the upgrade software may upgrade other devices in the network to allow or enhance interoperability with the new device. Another possibility is for the upgrade software to be provided on a recording medium having other content, for example a film or music. This allows networks to be upgraded without the involvement of the user.

The present invention has particular advantage when applied to a network of digitally connected devices which includes AV devices. Thus, the invention has particular application to an IEEE 1394 network. However, in general the present invention may be used with any type of network including, but not limited to, networks with hard-wire and/or wireless connections, USB, Ethernet, Bluetooth. For example, another type of network to which the present invention could be applied is a network of digital devices in a vehicle, such as an audio device, a navigation system and/or an engine control computer.

The present invention is applicable to a reproduction device for any type of recording medium. For example, currently a reproduction device for a CD or a DVD would be particularly suitable due to the widespread usage of these types of recording medium. However, the present invention is equally applicable to new formats of recording medium which are expected to become available in the future.

The present invention may be applied to a reproduction device of the type in which the controller is physically located in the reproduction device. However, the present invention could equally be applied to a system in which the controller for controlling the reproduction device is arranged in a separate device, for example in which the controller is implemented in a personal computer acting as a host controlling a separate reproduction device.

There are many ways for the controller to detect if the inserted recording medium has upgrade software recorded thereon. The preferred technique is for the recording medium to have recorded thereon data indicating the presence of the upgrade software and recording medium, which data is recorded in a region of the recording medium storing information about the data structure of data recorded on the recording medium. In the case of a CD, this region may be the TOC (table-of-contents) which is stored in the Q-channel of the lead-in area. In the case of a DVD, this region may be the area specifying the directory structure. Use of data in such a region is particularly advantageous because it simplifies the implementation of the present invention. In particular, it is common for controllers of known reproduction devices to automatically read such regions on insertion of a recording medium in the reproduction device as part of normal operation. Thus, the use of data in this region to indicate the presence of the update software allows the present invention to be implemented simply by including additional steps in the known process performed by a controller of a reproduction device on insertion of a recording medium.

To allow better understanding, an embodiment of the present invention will now be described by way of non-limitative example with reference to the accompanying drawings, in which:

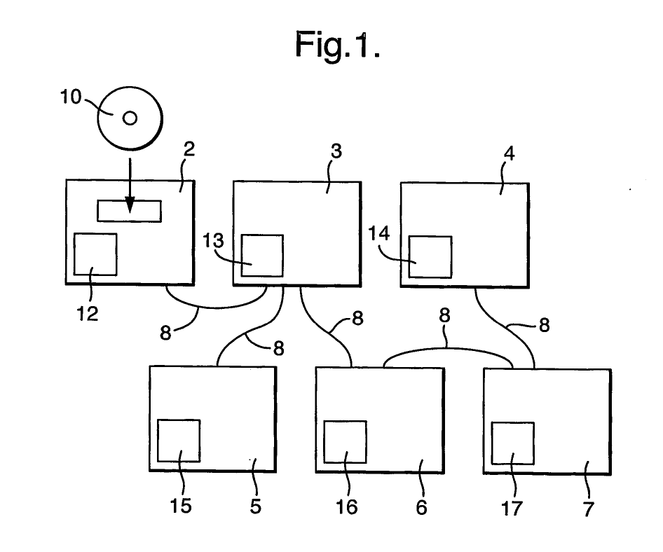

FIG. 1 is a schematic drawing of a network in accordance with the present invention; and

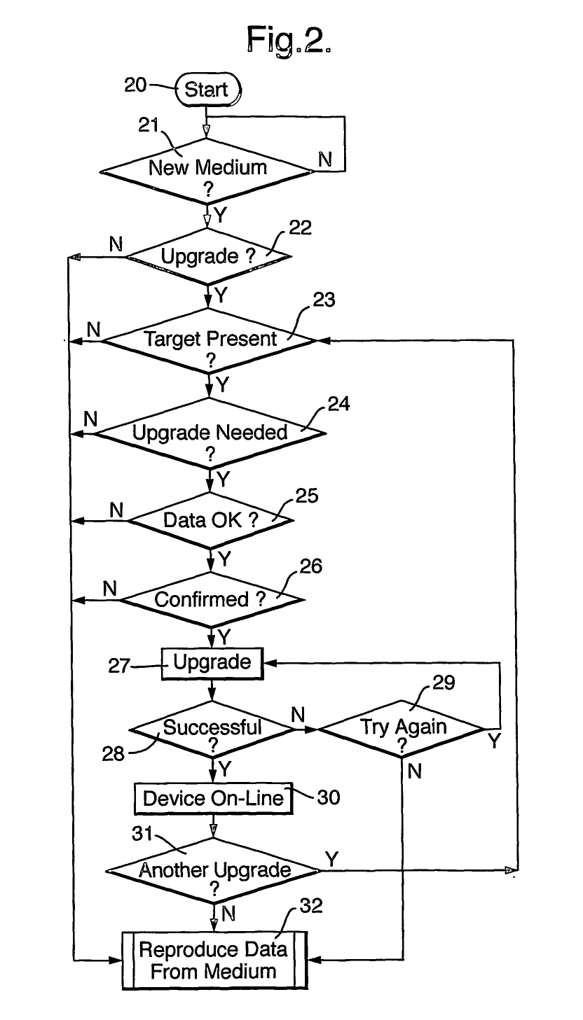

FIG. 2 is a flow chart of the operation performed by a controller of a reproduction device in the network of FIG. 1.

The network 1 illustrated in FIG. 1 comprises a plurality of digital devices 2 to 7 which are digitally interconnected. Six devices 2 to 7 are illustrated in FIG. 1 for illustration, but any number could in fact be provided. One device is a reproduction device 2 described in more detail below. The other devices 3 to 7 may be any type of digital device, preferably including at least one AV device such as a television or an audio amplifier. The devices 3 to 7 are all digital devices which operate under the control of software in a conventional manner. In particular, the devices 3 to 7 include respective microprocessors 13 to 17 for executing software stored in respective memories in the microprocessors 13 to 17.

The devices 2 to 7 are digitally connected by cables 8 to form an EEE 1394 bus. In particular, the individual devices 2 to 7 are connected in a daisy-chain fashion, although the specific connection pattern illustrated in FIG. 1 is merely for illustration. The present invention is equally applicable to any other form of network allowing devices to be digitally interconnected, including networks with hard-wired and/or wireless connections.

The reproduction device 2 is for reproducing a recording medium 10 which may, for example, be a CD or a DVD, insertable into the reproduction device 2. The reproduction device 2 has a conventional arrangement for receiving the recording medium 10 and reproducing data recorded on the recording medium 10. The reproduction device 2 has a controller 20 which controls operation of the reproduction device. The controller 20 may be implemented by a microprocessor running appropriate software.

The reproduction device 2 may be used to reproduce a recording medium 10 of a conventional type. However, the reproduction device 2 is also programmed to use a recording medium 10 having recording thereon upgrade software for one or more of the other devices 3 to 7 in the network 1. The upgrade software may be the only content stored on the recording medium 10, or alternatively, may be stored as extra data in addition to other content such as music or a film. The upgrade software may be software of any type including firmware, application software or device drivers.

A recording medium 10 storing upgrade software additionally stores upgrade control data to indicate the presence of upgrade software stored on the recording medium 10. The upgrade control data also provides information necessary to perform the update. This includes data identifying specific types of device in which the upgrade software may be used, data identifying the upgrade software and the issue number of the upgrade software.

The upgrade control data is stored in the region of the recording medium which stores information about the data structure of data recorded on the recording medium 10. In the case that the recording medium 10 is a CD, this is the TOC (table-of-contents) stored in the Q-channel of the lead-in area. In the case that recording medium 10 is a DVD, this is the region storing data specifying the directory structure of the recorded content data. The upgrade software is stored in the data region of the recording medium 10 with any other content.

There will now be described the process performed by the controller 12 of the reproduction device 2 on insertion of a recording medium 10 into the reproduction device 2, as illustrated in FIG. 2.

From an initial state 20, the process proceeds to step 21 in which it is checked whether a new recording medium 10 has been inserted into the reproduction device 2. If not, step 21 is repeated. Thus, on insertion of a recording medium the process proceeds to step 22.

In step 22, the controller 12 detects if the inserted recording medium 10 has upgrade software recorded thereon. This is done by checking for the presence of upgrade control data recorded on the recording medium. As the upgrade control data is recorded in the region of the recording medium storing the information about the data structure of the data recorded on the recording medium 10, step 22 may be performed an extra step in the processing conventionally performed on insertion of a recording medium 10 into the reproduction device 2.

If it is not detected in step 22 that the recording medium stores upgrade software, the controller proceeds to process 33 of reproducing any content data stored on the recording medium 10. The process 33 is the conventional process for the reproduction of data from a recording medium 10.

If it is detected in step 22 that the inserted recording medium 10 has upgrade software recorded thereon, the controller proceeds to step 23.

In step 23, the integrity of the data of the software upgrade reproduced from the recording medium 10 is checked. This check may be performed using conventional error detection techniques, the update software being recorded on the recording medium 10 is an appropriate redundant form. Optionally, error correction may also be performed. If the software upgrade includes errors which cannot be corrected, then the upgrade processing is abandoned and the controller proceeds to step 33. Otherwise, the controller 12 proceeds to step 24.

In step 24, the controller 12 checks whether the target device(s) specified in the upgrade control data is present in the network 1. If not, the upgrade process is abandoned and the controller proceeds to step 33. Otherwise, the controller proceeds to step 25.

In step 25, the controller 12 checks whether the target device(s) which are specified in the upgrade control data and are present in the network 1 need the upgrade. This check may be performed using the data specifying the upgrade software and the issue number stored in the upgrade control data. This is compared with the issue number of the corresponding software stored in the target device, which is retrieved from the target device if not already stored in the controller 12 of the reproduction device 2. If the upgrade is not needed, then the upgrade process is abandoned and the controller proceeds to step 33. Otherwise, the controller 12 proceeds to step 26.

In step 26, the user is asked to confirm whether the upgrade is desired. This may be achieved, for example, by the reproduction device 2 displaying on a display (not shown) information about the upgrade to which the user may respond by operating any appropriate input means (not shown) of the reproduction device, for example a keyboard. If the user does not confirm the upgrade, then the upgrade is abandoned and the controller 12 proceeds to step 33. If the user confirms the upgrade, the controller proceeds to step 27.

In step 27, the upgrade is performed. The controller 12 first sends a command to the target device(s) to take the target device(s) off-line. Then, the controller 12 sends an upgrade command, together with the upgrade software reproduced from the recording medium 10, to the target device(s) specified in the upgrade control data. In response to the upgrade command, the target device(s) performs the upgrade by storing the upgrade software in the memory of the respective microprocessor 12 to 17. This may involve overwriting of the previously stored software or the storage of additional software. This may be specified in the upgrade control data stored on the recording medium 10, in which case it is read by the controller 12 in step 22 and transferred to the target device(s) in the upgrade command.

After attempting to perform the upgrade, the target device(s) sends back a response to the reproduction device 2 to indicate whether or not the upgrade was successful. In step 28, the controller 12 checks this response. If the upgrade was not successful the controller proceeds to step 29 where the user is asked to confirm whether or not upgrading of the software should be attempted again. This may be done by causing the display means (not shown) of the reproduction device 2 to display a message to the user to prompt the user to operate the input device to confirm whether or not another attempt to upgrade should be made. If the user confirms this, the controller 12 repeats step S27. If not, the upgrade is abandoned and the controller proceeds to step 33.

If in step 28 it is found that the upgrade was successful, the controller proceeds to step 30. In step 30, the controller 12 sends a command to the target device(s) to put the target device(s) back on-line.

After step 30, the controller 12 proceeds to step 31 in which it is checked whether the upgrade control data provided from the recording medium 10 indicates that there is any other upgrade software on the recording medium. If so, the upgrade process is repeated by returning to step 23. If not, the upgrade process is finished and the controller 12 proceeds to step 33.

1. A network of digitally connected devices including a reproduction device for reproducing a recording medium insertable in the reproduction device,
wherein a controller for controlling the reproduction device is arranged, on insertion of a recording medium in the reproduction device, to perform a process comprising:
detecting if the inserted recording medium has recorded thereon upgrade software for upgrading a target device in the network; and
if it is detected that the inserted recording medium has upgrade software recorded thereon upgrade software, sending the upgrade software to the target device over the network and causing the target device to be upgraded by the upgrade software.

2. A network according to claim 1, wherein said step of causing the target device to be upgraded comprises sending the target device the upgrade software and an upgrade command for the upgrade device to perform the upgrade.

3. A network according to claim 1, wherein the step of detecting if the inserted recording medium has upgrade software recorded thereon comprises detecting data in a region of the recording medium storing information about the data structure of data recorded on the recording medium.

4. A network according to claim 1, wherein the devices include audio-visual devices.

5. A network according to claim 1, wherein the network is an IEEE 1394 network.

6. A network according to claim 1, wherein the controller is physically located in the reproduction device.

7. A controller for controlling a reproduction device for reproducing a recording medium insertable in the reproduction device which reproduction device is capable of digital connection to other devices in a network,
wherein the controller is arranged, on insertion in the reproduction device of a recording medium, to perform a process comprising:
detecting if the inserted recording medium has recorded thereon upgrade software for upgrading a target device in the network; and
if it is detected that the inserted recording medium has upgrade software recorded thereon upgrade software, sending the upgrade software to the target device over the network and causing the target device to be upgraded by the upgrade software.

8. A reproduction device for reproducing a recording medium insertable in the reproduction device which reproduction device is capable of digital connection to other devices in a network, the reproduction device comprising a controller for controlling the reproduction device, the controller being arranged, on insertion in the reproduction device of a recording medium, to perform a process comprising:
detecting if the inserted recording medium has recorded thereon upgrade software for upgrading a target device in the network; and
if it is detected that the inserted recording medium has upgrade software recorded thereon upgrade software, sending the upgrade software to the target device over the network and causing the target device to be upgraded by the upgrade software.

9. A method of upgrading devices in a network of digitally connected devices including a reproduction device for reproducing a recording medium insertable in the reproduction device, the method comprising:
detecting if the inserted recording medium has recorded thereon upgrade software for upgrading a target device in the network; and
if it is detected that the inserted recording medium has upgrade software recorded thereon upgrade software, sending the upgrade software to the target device over the network and causing the target device to be upgraded by the upgrade software.

10. A recording medium having recorded thereon:
upgrading software for upgrading a device capable of being digitally connected in a network to a reproduction device for reproducing the recording medium; and
data indicating the presence of the upgrade software on the recording medium.

11. A recording medium according to claim 10, wherein said data indicating the presence of the upgrade software on the recording medium is stored in a region of the recording medium storing information about the data structure of data recorded on the recording medium.
